(19) United States
(12) Patent Application Publication
(10) Pub. No.: US 2008/0077567 A1
(43) Pub. Date: Mar. 27, 2008

(54) Identification of job candidates based on statistical process

(76) Inventor: Larry Hartmann, Wyckoff, NJ (US)

Correspondence Address: KALIKO & YEAGER, L.L.C., 500 NORTH FRANKLIN TURNPIKE, RAMSEY, NJ, 07446, US

(21) Appl. No.: 11/524,813

(22) Filed: Sep. 21, 2006

(51) Int. Cl. G06F 17/30

(52) U.S. Cl. 707/5

(57) ABSTRACT

A method for identifying at least one candidate for a job is disclosed. The method includes calculating, for each candidate from a plurality of candidates, a list of attribute values and a first value based on the list of attribute values. The method further includes reading a list of ideal responses to a set of questions. The method further includes reading, for each candidate, a list of responses to the set of questions, wherein the list of responses were provided by the candidate. The method further includes calculating, for each candidate, a list of response values by comparing the list of ideal responses to the list of responses provided by the candidate. The method further includes calculating, for each candidate, a second value based on the list of response values and a third value based on the first value and the second value.

### FIELD OF THE INVENTION

The invention disclosed broadly relates to the field of staffing, and more particularly relates to the field of hiring processes using statistical methods.

### BACKGROUND OF THE INVENTION

Staffing companies match millions of people to millions of jobs. Currently, almost three million people per day are employed by staffing companies. A wide variety of methods are used to match job candidates to open positions. The process of staffing jobs, however, is not without its drawbacks. The odds of a successful hire are often no greater than 50 percent in today's workplace. Because highly qualified job candidates are not answering conventional ads, hiring managers are not trained interviewers, and the demand for talented professionals is high, the process becomes ever more difficult, time-consuming and expensive.

A commonly-used approach to matching job candidates to open positions involves the identification of a candidate's skills so as to match that candidate with an open position requiring those skills. Although this is a good way to find people who have the general qualifications for a particular job, there are a myriad of other characteristics and factors that are not considered when using this method. Another common approach to matching job candidates to open positions involves the use of directed questions to evaluate the job candidate. The results of the evaluation are used to compare the candidate to the open position and identify a match, if any. Again, although this approach may succeed in identifying certain similarities between a job candidate and a job, there are many other factors that should be taken into consideration when hiring the right person for an open position.

Therefore, a need exists to overcome the problems with the prior art as discussed above, and particularly for a more efficient way of selecting candidates for an open job position.

### SUMMARY OF THE INVENTION

Briefly, according to an embodiment of the present invention, a method for identifying at least one candidate for a job is disclosed. The method includes calculating, for each candidate from a plurality of candidates, a list of attribute values including a value for each attribute from a list of attributes. The method further includes calculating, for each candidate, a first value wherein the first value is calculated based on the list of attribute values. The method further includes reading a list of ideal responses to a set of questions, wherein the set of questions corresponds to the job and reading, for each candidate, a list of responses to the set of questions, wherein the list of responses were provided by the candidate. The method further includes calculating, for each candidate, a list of response values by comparing the list of ideal responses to the list of responses provided by the candidate, wherein the list of response values includes a value for each response from the list of responses. The method further includes calculating, for each candidate, a second value wherein the second value is calculated based on the list of response values, and calculating, for each candidate, a third value based on the first value and the second value.

In another embodiment of the present invention, a computer program product including computer instructions for identifying at least one candidate for a job is disclosed. The computer instructions include instructions for calculating, for each candidate from a plurality of candidates, a list of attribute values including a value for each attribute from a list of attributes. The computer instructions further include instructions for calculating, for each candidate, a first value wherein the first value is calculated based on the list of attribute values. The computer instructions further include instructions for reading a list of ideal responses to a set of questions, wherein the set of questions corresponds to the job and reading, for each candidate, a list of responses to the set of questions, wherein the list of responses were provided by the candidate. The computer instructions further include instructions for calculating, for each candidate, a list of response values by comparing the list of ideal responses to the list of responses provided by the candidate, wherein the list of response values includes a value for each response from the list of responses. The computer instructions further include instructions for calculating, for each candidate, a second value wherein the second value is calculated based on the list of response values, and calculating, for each candidate, a third value based on the first value and the second value.

In another embodiment of the present invention, a computer system for identifying at least one candidate for a job is disclosed. The computer system includes a processor configured for calculating, for each candidate from a plurality of candidates, a list of attribute values including a value for each attribute from a list of attributes. The processor is further configured for calculating, for each candidate, a first value wherein the first value is calculated based on the list of attribute values. The processor is further configured for reading a list of ideal responses to a set of questions, wherein the set of questions corresponds to the job and reading, for each candidate, a list of responses to the set of questions, wherein the list of responses were provided by the candidate. The processor is further configured for calculating, for each candidate, a list of response values by comparing the list of ideal responses to the list of responses provided by the candidate, wherein the list of response values includes a value for each response from the list of responses. The processor is further configured for calculating, for each candidate, a second value wherein the second value is calculated based on the list of response values, and calculating, for each candidate, a third value based on the first value and the second value.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram showing a high level system architecture 100 of a system for executing a candidate selection process, according to one embodiment of the present invention.

FIG. 2 is an illustration of a job attribute matrix used in a candidate selection process, according to one embodiment of the present invention.

FIG. 3 is an illustration of a candidate response list used in a candidate selection process, according to one embodiment of the present invention.

FIG. 4 is a block diagram showing the components and data used during the candidate selection process, according to one embodiment of the present invention.

FIG. 5 is a flowchart showing the control flow of the candidate selection process, according to one embodiment of the present invention.

FIG. 6 is a block diagram showing an embodiment of a computer system useful for implementing an embodiment of the present invention.

### DETAILED DESCRIPTION

It should be understood that the embodiments below are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawing like numerals refer to like parts through several views.

The present invention, according to a preferred embodiment, overcomes problems with the prior art by providing an improved system, method and computer program product for selecting candidates for a particular job using statistical processes. The present invention greatly increases the odds of selecting and hiring the best candidates for a particular job. The present invention further provides a unique assessment process that identifies the best qualities of a business' employees and then using these qualities to search for candidates from a pool. One advantage of the present invention is an increase in the odds of making the best hire for a new position. Another advantage of the present invention is a reduction in hiring costs and a reduction in expensive turnover in existing job positions (i.e., higher retention rates). Yet another advantage of the present invention is a reduction in company time spent on the hiring process.

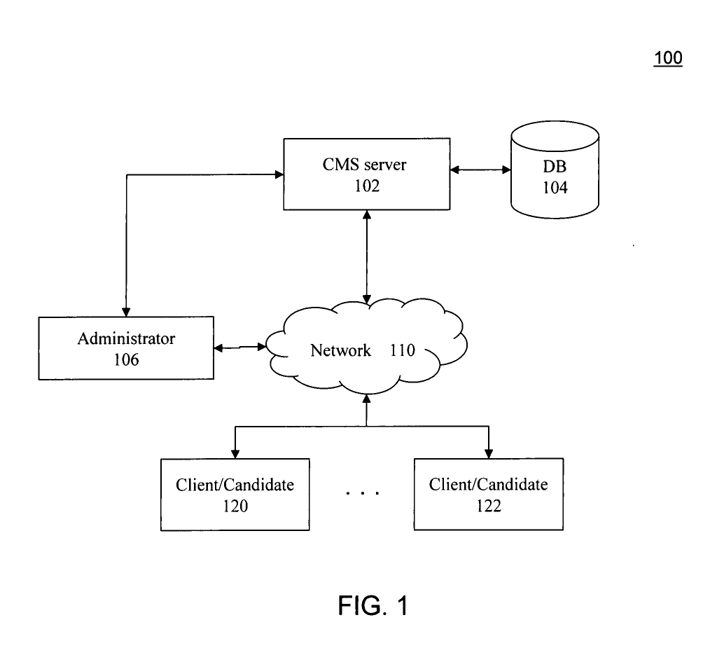

FIG. 1 is a block diagram showing a high level system architecture of system 100 for executing a candidate selection process, according to one embodiment of the present invention. FIG. 1 illustrates the client-server architecture of one embodiment of the present invention. The exemplary embodiments of the present invention adhere to the system architecture of FIG. 1. FIG. 1 shows a candidate management system (CMS) server 102 connected to the network 110. The CMS server 102 (which is described in more detail below) substantially performs the candidate selection processes of the present invention.

FIG. 1 further shows an embodiment of the present invention wherein clients, or job candidates, interact with the CMS server 102 over a network 110, such as in an enterprise implementation of the management system 100 that services multiple job candidates in more than one location. FIG. 1 shows client computers 120 through 122 connected to a network 110. Client computers 120-122 comprise job candidates running a client application on the client computer so as to participate the candidate selection process. It should be noted that although FIG. 1 shows only two client computers 120 and 122, the system of the present invention supports any number of client computers.

Finally, an administrator client 106 is shown to be connected either to the network 110 or directly to the CMS server 102. The administrator client 106 is used to administer the CMS server 102 and therefore the administrator client can be remotely located via the network 110 or situated within the same intranet as the CMS server 102.

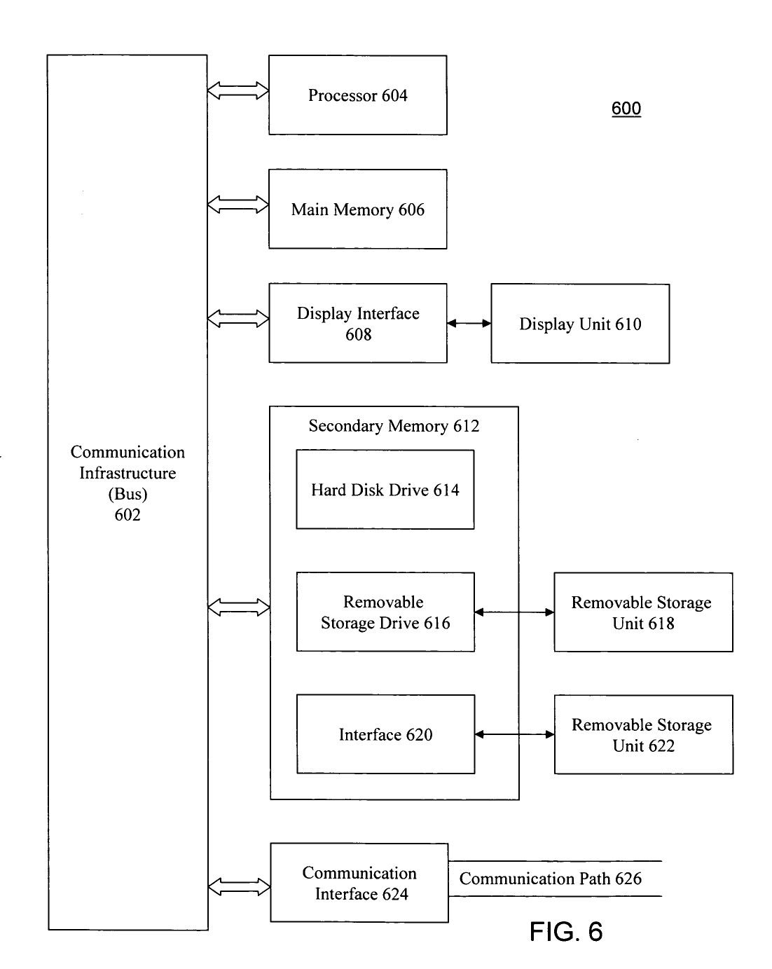

In an embodiment of the present invention, the computer systems of client computers 120 through 122, administrator client 106 and CMS server 102 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the client computers 120 through 122, administrator client 106 and CMS server 102 are a server system, such as SUN Ultra workstations running a SunOS operating system or IBM RS/6000 workstations and servers running the AIX operating system. The computer systems of client computers 120 through 122, administrator client 106 and CMS server 102 are described in greater detail below with reference to FIG. 6.

In an embodiment of the present invention, the network 110 is a circuit switched network, such as the Public Service Telephone Network (PSTN). In another embodiment, the network 130 is a packet switched network. The packet switched network is a wide area network (WAN), such as the global Internet, a private WAN, a local area network (LAN), a telecommunications network or any combination of the above-mentioned networks. In yet another embodiment, the structure of the network 110 is a wired network, a wireless network, a broadcast network or a point-to-point network.

Optionally, the CMS server 102 includes a Web server that connects to the network 110 via a network interface. The CMS server 102 is logically connected to the Web server, which provides a Web interface available to clients (such as clients 120 through 122). This option is advantageous as a Web interface allows any clients having a Web connection to connect to the CMS server 102. A Web interface provides a simple, efficient, highly compatible, economical and highly available connection to the CMS server 102 to a wide range of clients.

Also shown in FIG. 1 is a database 104 coupled with the CMS server 102. The database 104 is a repository for data and includes all information necessary for performing the functions of the system 100. Database 104 can be any commercially database, such as an Oracle Database, Enterprise or Personal Edition, available from Oracle Corporation, or a Microsoft SQL Server or Access 2000 database available from Microsoft Corporation. Database 104 may further be managed by a database management system, which is an application that controls the organization, storage and retrieval of data (fields, records and files) in the databases. A database management system accepts requests for data from an application program and instructs the operating system to transfer the appropriate data. A database management system may also control the security and integrity of a database. Data security prevents unauthorized users from viewing or updating certain portions of the database. A database management system can be any commercially database management system, such as the Oracle E-Business Suite available from Oracle Corporation.

Each client 120-122 runs a client application, such as an application programmed in C++, Visual Basic, a Java applet, a Java scriptlet, Java script, Perl script, an Active X control or any self-sufficient application executing on a client computer. It should also be noted that in the embodiment of the present invention described above, the clients 120-122 and administrator 106 are depicted as separate from CMS server 102. In an alternative embodiment of the present invention, any one or all of the clients 120-122 and administrator 106 can be integrated, along with CMS server 102. In this alternative embodiment, those entities that are integrated share the same resources.

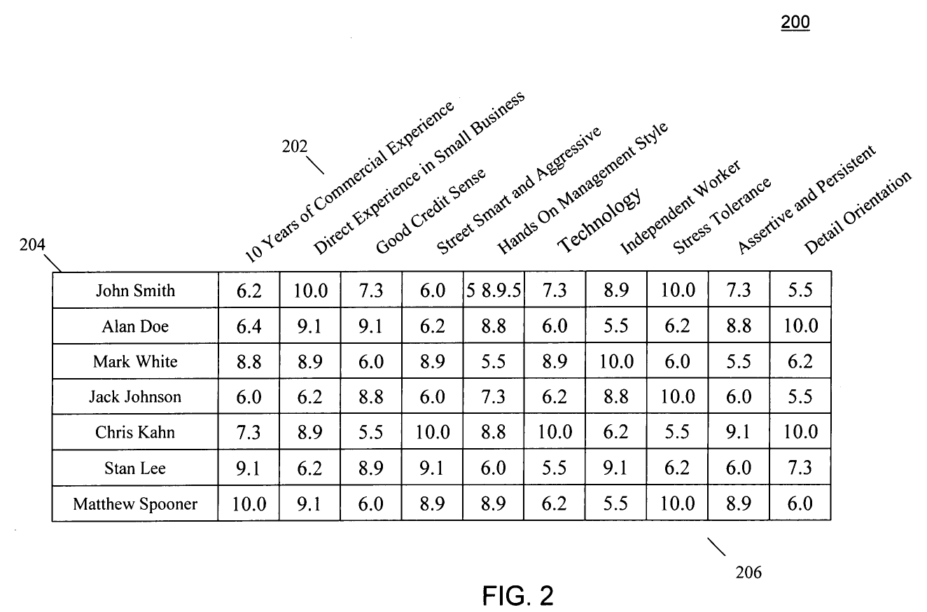

FIG. 2 is an illustration of a job attribute matrix 200 used in a candidate selection process, according to one embodiment of the present invention. FIG. 2 shows a matrix 200 containing attribute values for a list of attributes for each of a plurality of candidates. Matrix 200 shows a list of attributes and skills located along the top row 202. Although, any number of attributes and skills may be located along the top row 202, the current matrix 200 shows ten attributes and skill. Matrix 200 further shows a list of job candidate names along the left-most column 204. The body 206 of the matrix 200 includes the attributes values calculated for each candidate. That is, the body 206 of the matrix 200 shows, for each candidate, the value calculated for each attribute and skill located along the top row 202.

In an embodiment of the present invention, the data required to create the attribute values of matrix 200 above are garnered through questionnaires that are provided to each candidate. The questionnaires include questions from which the candidates' skills and attributes can be gleamed from the responses. In one alternative, the questionnaires are provided in paper format to each candidate, who proceeds to fill out the form and return it to an administrator who enters the relevant data into the database 104. In another alternative, the questionnaires are provided in Web form to each candidate via a Web page to the client computer 120-122. The candidates proceed to fill out the forms online and subsequently the relevant data is automatically entered into the database 104.

In another embodiment of the present invention, the attribute values calculated for the body 206 of the matrix 200 can be calculated in a variety of ways. In one alternative, at attribute value ranges from 1-10 and the value is calculated based on the data garnered from the candidate. For example, for the attribute “10 years of commercial experience,” the candidate is given an attribute value of 10 if he possesses 10 years or more of commercial experience. If the candidate possesses less than 10 years of commercial experience, he is given an attribute value equal to the number of years of experience he possesses. In another example, for the attribute “Stress tolerance,” the candidate is given an attribute value of 10 if, based on his questionnaire responses, he possesses the greatest amount of stress tolerance. For lowers amounts of stress tolerance, the candidate is given a lower attribute value up to a zero attribute value for possessing no stress tolerance qualities. Attribute values can be calculated based on the candidate's responses to questions in the questionnaires, the candidate's reactions to certain test scenarios, the candidate's personality test results, third party assessments of the candidate or any combination of the former

The matrix 200 shown in FIG. 2 shows attribute values for a list of attributes and skills. In another embodiment of the present invention, the matrix 200 can include attribute values for behavioral characteristics, wherein the attribute values can be calculated based on the candidate's responses to questions in the questionnaires, the candidate's reactions to certain test scenarios, the candidate's personality test results, third party assessments of the candidate or any combination of the former.

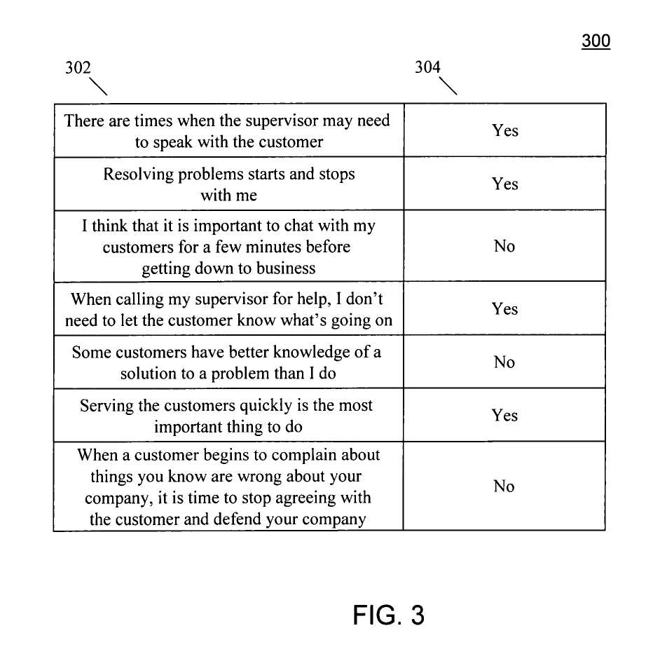

FIG. 3 is an illustration of a candidate response list 300 used in a candidate selection process, according to one embodiment of the present invention. FIG. 3 shows a list 300 containing one candidate's responses to a list of questions pertinent to the job for which the candidate is applying. List 300 shows a list of questions located along the left-most column 302. Although, any number of questions may be located along the left-most column 302, the current list 300 shows seven questions. List 300 further shows the candidate's response to each question along the right-most column 304.

In an embodiment of the present invention, the responses from list 300 above are garnered through questionnaires that are provided to each candidate. The questionnaires include questions from which the candidates' skills and attributes can be gleamed from the responses. In one alternative, the questionnaires are provided in paper format to each candidate, who proceeds to fill out the form and return it to an administrator who enters the relevant data into the database 104. In another alternative, the questionnaires are provided in Web form to each candidate via a Web page to the client computer 120-122. The candidates proceed to fill out the forms online and subsequently the relevant data is automatically entered into the database 104.

In an embodiment of the present invention, a corresponding list of ideal responses to the set of questions of list 300 can be generated. That is, whereas list 300 shows a list of a candidate's responses to a set of questions, an administrator can generate a list of ideal responses to the same set of questions, wherein the ideal responses are generated by a person who is currently employed in the job for which the candidates are being evaluated. The logic behind using a list of ideal responses revolves around the belief that a current employee who holds the job position successfully will produce responses to the set of questions which should be emulated by job candidates. Finding job candidates with responses similar or identical to the ideal list of responses increases the chances of hiring a candidate that will equally excel at the job position.

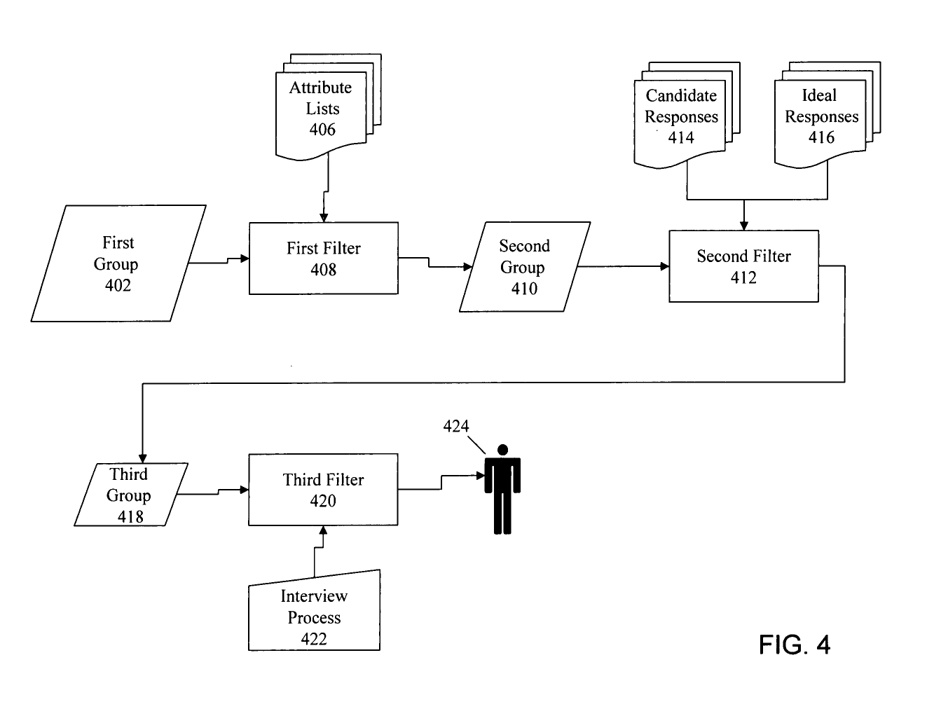

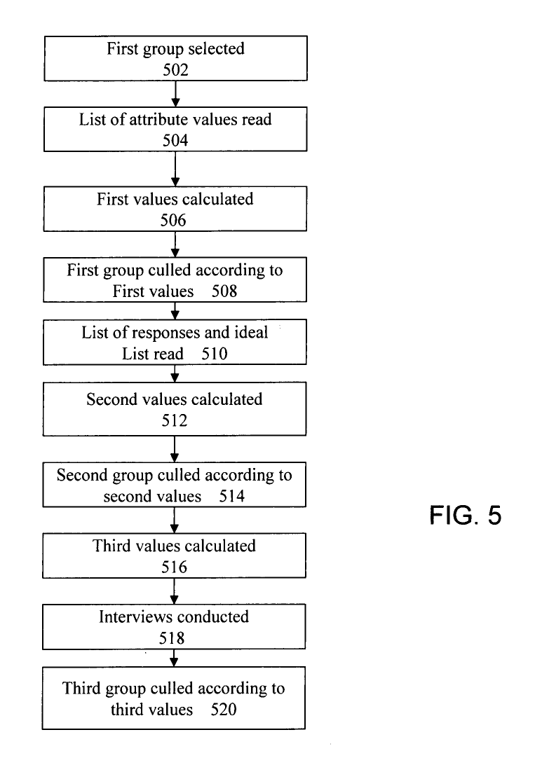

FIG. 4 is a block diagram showing the components and data used during the candidate selection process, according to one embodiment of the present invention. FIG. 5 shows a group of job candidates 402 selected as the initial pool from which the candidate selection will occur. The first filter 408 is executed by reading a list of attribute values 406 for each candidate in the group 402. The first group 402 is culled by the first filter 408, thereby generating second group 410 of candidates, which is smaller than first group 402.

The second filter 412 is executed by reading a list 416 of ideal responses to a set of questions and, for each candidate in the group 410, a list 414 of responses to the same set of questions. The second group 410 is culled by the second filter 412, thereby generating third group 418 of candidates, which is smaller than second group 410. The second group 410 is further culled by filter 420, thereby generating a final group 424 of one or more candidates, which is smaller than third group 418. Optionally, the third filter 420 can further effectuated by conducting a live interview of the remaining candidates in group 418. Based on the results of the interview, candidates can be eliminated from consideration or given scores on their interview performance.

FIG. 5 is a flowchart showing the control flow of the candidate selection process, according to one embodiment of the present invention. FIG. 5 begins with step 502, wherein a group of job candidates 402 are selected as the initial pool from which the candidate selection will occur. In step 504, the first filter 408 is executed by reading a list of attribute values 406 for each candidate in the group 402. That is, for each candidate in the group 402, the CMS server 102 reads an attribute value list 406, similar or identical to matrix 200. In step 506, the CMS server 102 calculates a first value for each candidate in group 402, wherein the first value for each candidate is based on the attribute values corresponding to that candidate.

In an embodiment of the present invention, the first value calculated for each candidate as a simple sum or average. For example, referring to the attribute values corresponding to candidate John Smith in matrix 200, the first value can be a sum of the attribute values for John Smith or the first value may be an average of the attribute values. In another embodiment of the present invention, a first value can be calculated for a candidate by taking a weighted average of the attribute values for that candidate, wherein weights are associated with certain attribute values. For example, it may be the case that of all the attributes in matrix 200, the attributes “Stress tolerance” and “Detail orientation” are more important than the others. In this case, a first value for candidate John Smith can be calculated by taking an average of the attribute values for John Smith, with extra weight being given to attribute values for attributes “Stress tolerance” and “Detail orientation.”

In step 508, the first group 402 is culled by eliminating those candidates with a first value below a predetermined threshold value, thereby generating second group 410 of candidates, which is smaller than first group 402.

In step 510, the second filter 412 is executed by reading a list 416 of ideal responses to a set of questions and, for each candidate in the group 410, a list 414 of responses to the same set of questions. That is, for each candidate in the group 410, the CMS server 102 reads a list 414 of responses, similar or identical to list 300. In step 512, the CMS server 102 calculates a second value for each candidate in group 410, wherein the second value for each candidate is based on a comparison of the list 414 of responses with list 416 of ideal responses.

In one embodiment of the present invention, the second value can be calculated by simply calculating the number or percentage of candidate responses that coincide with the ideal responses. In one alternative, a candidate's second value is increased a certain amount for each response that coincides with an ideal response. In another embodiment of the present invention, a second value can be calculated for a candidate by taking a weighted average of the percentage of the candidate's responses that coincide with the ideal responses, wherein weights are associated with certain responses. For example, it may be the case that of all the responses in list 414, the first two responses are more important than the others. In this case, a second value for a candidate can be calculated by taking an average of the percentage of the candidate's responses that coincide with the ideal responses, with extra weight being given to the first two responses.

In step 514, the second group 410 is culled by eliminating those candidates with a second value below a predetermined threshold value, thereby generating third group 418 of candidates, which is smaller than second group 410.

In step 516, the third filter 420 is executed by calculating a third value for each candidate in group 418, wherein the third value for each candidate is based on a combination of the first and second value. In one embodiment of the present invention, the third value can be calculated by simply summing or averaging the first and second values. In another alternative, the third value can be calculated by using a formula involving the first and second values, such as: two thirds of the first value plus one third of the second value. In another alternative, a weighted average can be taken of the first and second values, wherein the first value is given a weight of two thirds and the second value is given a weight of one third.

In optional step 518, the third filter 420 can further effectuated by conducting a live interview of the remaining candidates in group 418. Based on the results of the interview, candidates can be eliminated from consideration or given scores on their interview performance.

In step 520, the second group 410 is culled by eliminating those candidates with a second value below a predetermined threshold value, thereby generating a final group 424 of one or more candidates, which is smaller than third group 418.

FIG. 6 is a block diagram showing an embodiment of a computer system 600 useful for implementing an embodiment of the present invention. The present invention can be realized in hardware, software, or a combination of hardware and software in the system described in FIG. 6. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, which allows a computer system to read such computer readable information.

FIG. 6 is a block diagram of a computer system useful for implementing an embodiment of the present invention. The computer system 600 of FIG. 6 is a more detailed representation of computers 120 through 122, administrator 106 or server 102. The computer system 600 of FIG. 6 includes one or more processors, such as processor 604. The processor 604 is connected to a communication infrastructure 602 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system 600 can include a display interface 608 that forwards graphics, text, and other data from the communication infrastructure 602 (or from a frame buffer not shown) for display on the display unit 610. The computer system 600 also includes a main memory 606, preferably random access memory (RAM), and may also include a secondary memory 612. The secondary memory 612 may include, for example, a hard disk drive 614 and/or a removable storage drive 616, representing a floppy disk drive, a magnetic tape drive, an optical disk drive, etc. The removable storage drive 616 reads from and/or writes to a removable storage unit 618 in a manner well known to those having ordinary skill in the art. Removable storage unit 618, represents, for example, a floppy disk, magnetic tape, optical disk, etc. which is read by and written to by removable storage drive 616. As will be appreciated, the removable storage unit 618 includes a computer usable storage medium having stored therein computer software and/or data.

In alternative embodiments, the secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computer system.

The computer system may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (i.e., channel) 626. This channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, which allow a computer to read such computer readable information.

Computer programs (also called computer control logic) are stored in main memory 606 and/or secondary memory 612. Computer programs may also be received via communications interface 624. Such computer programs, when executed, enable the computer system to perform the features of the present invention as discussed herein. In particular, the computer programs, when executed, enable the processor 604 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for identifying at least one candidate for a job, comprising:
calculating, for each candidate from a plurality of candidates, a list of attribute values including a value for each attribute from a list of attributes;
calculating, for each candidate, a first value wherein the first value is calculated based on the list of attribute values;
reading a list of ideal responses to a set of questions, wherein the set of questions corresponds to the job;
reading, for each candidate, a list of responses to the set of questions, wherein the list of responses were provided by the candidate;
calculating, for each candidate, a list of response values by comparing the list of ideal responses to the list of responses provided by the candidate, wherein the list of response values includes a value for each response from the list of responses;
calculating, for each candidate, a second value wherein the second value is calculated based on the list of response values; and
calculating, for each candidate, a third value based on the first value and the second value.

2. The method of claim 1, wherein the first step of calculating further comprises:
calculating, for each candidate from a plurality of candidates, a list of attribute values including a value for each attribute from a list of attributes, wherein each attribute is pertinent to the job.

3. The method of claim 2, wherein the second step of calculating further comprises:
calculating, for each candidate, a first value wherein the first value is calculated based on the list of attribute values and weights associated with each attribute value.

4. The method of claim 1, wherein the first step of reading further comprises:
reading a list of ideal responses to a set of questions, wherein the set of questions corresponds to the job and wherein the ideal responses were provided by an ideal employee holding the job.

5. The method of claim 4, wherein the second step of reading further comprises:
reading, for each candidate, a list of responses to the set of questions, wherein the list of responses were provided by the candidate over the Web.

6. The method of claim 5, wherein the fourth step of calculating further comprises:
calculating, for each candidate, a second value wherein the second value is calculated based on the list of response values and weights associated with each response value.

7. The method of claim 6, wherein the fifth step of calculating further comprises:
calculating, for each candidate, a third value comprising two-thirds of the first value and one-third of the second value.

8. The method of claim 1, further comprising:
setting an interview with any candidate from the plurality of candidates with a third value that exceeds a threshold value.

9. A computer program product including computer instructions for identifying at least one candidate for a job, the computer instructions including instructions for:
calculating, for each candidate from a plurality of candidates, a list of attribute values including a value for each attribute from a list of attributes;
calculating, for each candidate, a first value wherein the first value is calculated based on the list of attribute values;
reading a list of ideal responses to a set of questions, wherein the set of questions corresponds to the job;
reading, for each candidate, a list of responses to the set of questions, wherein the list of responses were provided by the candidate;
calculating, for each candidate, a list of response values by comparing the list of ideal responses to the list of responses provided by the candidate, wherein the list of response values includes a value for each response from the list of responses;
calculating, for each candidate, a second value wherein the second value is calculated based on the list of response values; and
calculating, for each candidate, a third value based on the first value and the second value.

10. The computer program product of claim 9, wherein the first instructions for calculating further comprise instructions for:
calculating, for each candidate from a plurality of candidates, a list of attribute values including a value for each attribute from a list of attributes, wherein each attribute is pertinent to the job.

11. The computer program product of claim 10, wherein the second instructions for calculating further comprise instructions for:
calculating, for each candidate, a first value wherein the first value is calculated based on the list of attribute values and weights associated with each attribute value.

12. The computer program product of claim 9, wherein the first instructions for reading further comprise instructions for:
reading a list of ideal responses to a set of questions, wherein the set of questions corresponds to the job and wherein the ideal responses were provided by an ideal employee holding the job.

13. The computer program product of claim 12, wherein the second instructions for reading further comprise instructions for:
reading, for each candidate, a list of responses to the set of questions, wherein the list of responses were provided by the candidate over the Web.

14. The computer program product of claim 13, wherein the fourth instructions for calculating further comprise instructions for:
calculating, for each candidate, a second value wherein the second value is calculated based on the list of response values and weights associated with each response value.

15. The computer program product of claim 14, wherein the fifth instructions for calculating further comprise instructions for:
calculating, for each candidate, a third value comprising two-thirds of the first value and one-third of the second value.

16. The computer program product of claim 9, further comprising instructions for:
setting an interview with any candidate from the plurality of candidates with a third value that exceeds a threshold value.

17. A computer system for identifying at least one candidate for a job, comprising a processor configured for:
calculating, for each candidate from a plurality of candidates, a list of attribute values including a value for each attribute from a list of attributes;
calculating, for each candidate, a first value wherein the first value is calculated based on the list of attribute values;
reading a list of ideal responses to a set of questions, wherein the set of questions corresponds to the job;
reading, for each candidate, a list of responses to the set of questions, wherein the list of responses were provided by the candidate;
calculating, for each candidate, a list of response values by comparing the list of ideal responses to the list of responses provided by the candidate, wherein the list of response values includes a value for each response from the list of responses;
calculating, for each candidate, a second value wherein the second value is calculated based on the list of response values; and
calculating, for each candidate, a third value based on the first value and the second value.

18. The computer system of claim 17, wherein the first step of calculating further comprises:
calculating, for each candidate from a plurality of candidates, a list of attribute values including a value for each attribute from a list of attributes, wherein each attribute is pertinent to the job.

19. The computer system of claim 18, wherein the second step of calculating further comprises:
calculating, for each candidate, a first value wherein the first value is calculated based on the list of attribute values and weights associated with each attribute value.

20. The computer system of claim 17, wherein the first step of reading further comprises:
reading a list of ideal responses to a set of questions, wherein the set of questions corresponds to the job and wherein the ideal responses were provided by an ideal employee holding the job.
